(19) United States
(12) Patent Application Publication
(10) Pub. No.: US 2022/0108249 A1
(43) Pub. Date: Apr. 7, 2022

(54) METHOD AND APPARATUS FOR WORKFLOW AUTOMATION

(71) Applicant: Sanjay Chandramohan Maheshwari, Surat (IN)

(72) Inventor: Sanjay Chandramohan Maheshwari, Surat (IN)

(21) Appl. No.: 17/422,343

(22) PCT Filed: Jan. 13, 2020
(86) PCT No.: PCT/IN2020/050040

§ 371 Date: Jul. 12, 2021

(30) Foreign Application Priority Data
Jan. 12, 2019 (IN) 201921001497

(51) Int. Cl. G06Q 10/06

(52) U.S. Cl. CPC G06Q 10/06316; G06Q 10/0633

(57) ABSTRACT

Disclosed is an apparatus for developing a process flow to allow an user to execute a manufacturing process, the apparatus comprises: a) a data connector for allowing data connections between the apparatus and various associated input resources; a job ticket comprises various data sections required by the process for manufacturing; a job ticket generator for allowing user interaction to carry out a plurality of task and automatically generate the Job ticket from incoming order data; a process creator to define and create the process with stages for user defined process execution; b) postal agents for moving a job ticket to its next destination based on tracking of information and updates the current status of the job and transmits to a control panel; c) a job ticket server making available the applicable job ticket for execution of task, to a particular stage in the process; a processing client for initiating a call to an end point; and configurable end points; and d) a control panel for displaying the status of the process flow development, wherein the components (a to d) being connected together in a network.

### FIELD OF THE INVENTION

The present invention relates to an apparatus and method for automating the workflow processes related to manufacturing or management using a data file containing the workflow data and information, configurable end points of Process stages and network of digital Postal agents. The present invention further provides the method and apparatus for the user to define its own workflow process. The present invention also provides the means to interface with the existing data sources like ERP etc., at both the terminal ends. At the starting point to source the data for the workflow from the data sources and at the terminating point to store the outcome back into the data sources.

### BACKGROUND OF THE INVENTION

For last several decades IT has been used to improve the productivity and quality by enforcing best practices in workflow processes involved in manufacturing as well as management. However, these were usually applied to mass manufacturing and management practices that were followed at production scale. This led to proliferation of ERP and MIS systems. These systems typically serviced the requirements of workflows that were defined largely with static boundaries and implemented as organization wide practices. This would also mean that there was a little scope for experimentation outside of the box, which was fine as there was a little need for it. The manufacturing processes were mostly geared for mass scale production and management practices were usually implemented in a sequential and well-planned manner. The focus was more on managing mass production, production efficiency, logistics and distribution to the last mile of fulfillment, where the customer would actually make a choice from the given.

The advent of digital technologies opened up possibilities of interacting with the customers even before the production has started. Customers through these interactions are making customization choices for the products before they are produced for them. The new age digitally controlled production machines are capable of producing shorter runs more efficiently. Examples of such technologies can be seen in digital printing, digital fabric weaving etc. So effectively, we are witnessing a proliferation of processes and manufacturing technologies that are geared up towards short runs and mass customization lead by customer's choice at the center of it. In addition, the trend is towards more and more automated manufacturing either computer controlled or using robots in the process.

Therefore, there is a need of a workflow apparatus that is not only dynamic in nature but also adaptable to changing needs of the customer centric manufacturing, which can also meet the requirement of the changing landscape of manufacturing involving the digital machines and robots.

All this needs to be achieved without breaking the back of the current IT systems or in other words something that will cooperatively coexist with the current IT systems.

### OBJECTS OF THE INVENTION

In view of the foregoing limitations inherent in the state of the art, some of the objects of the present disclosure, which at least one embodiment herein satisfy, are listed herein below.

(1) The object of the present invention is to define a method/apparatus that is able to allow the user to dynamically define the multiple workflows.

(2) Another object of the present invention is to allow the user to gather, generate and use data to complete the workflow.

(3) Still another object of the present invention is to automate the entire workflow process as defined by the user.

(4) Yet another object of the present invention is to provide the end results or data to the existing IT systems for verification and storage, consolidation and further action.

(5) Still yet another object of the present invention is to define an apparatus to achieve the above objectives.

### SUMMARY

One or more drawbacks of conventional system/method for workflow automation and other problems are overcome, and additional advantages are provided through the apparatus in the present disclosure. Additional features and advantages are realized through the technicalities of the present disclosure. Other embodiments and aspects of the disclosure are described in detail herein and are considered to be part of the claimed disclosure.

The present invention is directed to an apparatus for developing a process flow to allow an user to execute a manufacturing process, the apparatus comprises: at least a Data Connector for allowing data connections between the apparatus and various associated input resources sequentially disposed including mapping between the data fetched and a Job Ticket derivable from the order data; the job ticket comprises various data sections applicable to the process for manufacturing; at least a Job Ticket Generator for allowing user interaction with the input resources to carry out a plurality of task; and

at least a Process Creator to define and create the process Stages for the Process execution based on transformed data from the input resources; at least one Postal Agent for moving a job ticket to its next destination based on so tracking of information available inside the job ticket and updates the current status of the job and transmits to a control panel in every steps; at least one Job Ticket Server making available the applicable job ticket for execution of task, to a particular stage in the process;
at least one Processing Client present at a processing stage for initiating a call to an End Point, along with the job related data; and at least one end point configurable for multitasking, connectable to a machine or a service or combination of both assigned for processing the incoming job, and at least a control panel for displaying the status of the process flow development at any given point of time, wherein the components of said apparatus operably being connected in a network.

The preferred embodiment of the present invention is having other features and advantages which are disclosed in the appended dependent claims.

### BRIEF DESCRIPTION OF THE ACCOMPANYING DRAWINGS

The illustrated embodiments of the subject matter will be best understood by reference to the drawings, wherein like parts are designated by like numerals throughout. The following description is intended only by way of example, and simply illustrates certain selected embodiments of apparatus that are consistent with the subject matter as claimed herein, wherein:

FIG. 1 illustrates the typical workflow along with the various components of the apparatus.

FIG. 2 illustrates the process creator for user defined workflow process. An example process for Garment Decoration called “Full Process” is shown created in the Figure, consisting of Material Allocation, Pre-treatment and Print Stages. The Material Allocation stage is located at computer named M1 in the network. The Pre-treatment stage is located at computer named PT1 in the network and the Print Stage is located at computer named PR in the network.

FIG. 3 illustrates how the user can define the Data Connectors. An no example data connection is shown established with the Excel database and mappings created to link this data to fields in Job ticket. A Data Connector thus created, can be used to automatically generate the Job Ticket based on incoming order data.

FIG. 4 illustrates a Control Panel showing the progress update of us various Jobs in the workflow along with various control it offers over a Job.

FIG. 5 illustrates the process of garment printing stages of the preferred embodiment.

### DESCRIPTION OF THE INVENTION

The detailed description of various exemplary embodiments of the disclosure is described herein with reference to the accompanying drawings. It should be noted that the embodiments are described herein in such details as to clearly communicate the disclosure. However, the amount of details provided herein is not intended to limit the anticipated variations of embodiments; on the contrary, the intention is to cover all modifications, equivalents, and alternatives falling within the spirit and scope of the present disclosure as defined by the appended claims.

A typical manufacturing workflow covers the lifecycle of a manufacturing process, i.e., from order to shipment. The manufacturing process itself can comprise of several stages of input raw material transformations and other allied activities. Each of these stages and activities are required to be executed in a certain sequence. The specific data is required by each stage/activity to execute. Since, orders can be for customized product, this data is dynamic in nature, based on the order. This creates an implicit requirement for the manufacturing process to be dynamic and adaptable in execution and be able be to handle the dynamic nature of the order data resulting from the customization requirements. Consequentially, each time the manufacturing process is executed, it has to handle the differences in requirements of individual customers. In addition, the workflow apparatus should be able to adapt itself to handle any new manufacturing process involving machines or interfaces that may not be known prior or needs to be included later.

The starting point of a manufacturing workflow is the order information. In today's manufacturing environment quite often, the order is given to Vendor A is fulfilled by another Vendor B. Further in this digital age, the connection to the customer is through variety of means, e.g., multiple different sales portals, mobile apps, and good old point of sale counters etc. This essentially means that the order data itself will not be uniform in nature. Different sources of order will have their order data stored in different formats and may have some variations in content.

Therefore, the workflow apparatus should enable the user to accomplish iso the following steps:
A. Define a manufacturing processes, comprising the sequence of process stages and activities in order of their execution.
B. Define methods of adapting the order data to the process in order to meet the customer requirements.
C. Connect to different sources of order data and generate the common homogenized Job description/data file to be used in the process of manufacturing.
D. Define a mechanism to reliably transport and make the data available to the process stage, relevant to its execution while enforcing the sequence of execution as defined in the process definition.
E. Create connections to the machines and interfaces used at various stages in the manufacturing process.
F. Collect the output or resultant data from every stage for storage, subsequent actions and post production analysis.
G. Have a dashboard to control and get a bird's eye view of manufacturing at any point in time.

All the above steps are carried out considering that the details and execution of the manufacturing process are all user definable/programmable and nothing in that context is pre-defined or pre-programmed.

The illustration of the above steps which are related to the objects of this invention, are given. The Step A, helps achieve the objective 1. Steps B and C, helps achieve the objective 2. Steps D, E and G, helps achieve the objective 3. Step F, helps achieve the objective 4.

The apparatus comprises of the following components: —
(1) Data Connectors
(2) Job Ticket
(3) Stage and Process (Process Creator)
(4) Job Ticket Generator
(5) Postal Agent
(6) Job Ticket Server
(7) Processing Client
(8) Configurable End Points
(9) Control Panel

The components (1) to (4), help realize the steps A, B, C defined previously, working in cooperation with each other. Components (5) to (7), help realize the steps D and F, working in cooperation with each other. Component (8) help realize the step E and Component (9) help realize the step G.

Detailed description of these components of said apparatus are illustrated in below: —
(1) Data Connector—It allows the “data connection” between the apparatus and the various sources of order input. Each source of order may be having its own data format. The Data Connector also establishes the mapping between the data fetched from the order source and the Job Ticket to be generated by the apparatus from the order data. This data connection definition established by the Data Connector is utilized by the Job Ticket Generator to automatically generate the Job Ticket for order processing, the very moment an order arrives.
(2) Job Ticket—The Job Ticket comprises of various data sections. A section is a logical organization of related data. The data related to the order is organized as one section. The data to be used by a particular stage of processing is organized as another section. A Job Ticket thus, will contain at least as many sections as the number of Stages in the Process of manufacturing. The Job Ticket thus contains all the data required by the Process for manufacturing. The Job Ticket is a data file with tagged data. The data is uniquely tagged to describe and identify it. The Job Ticket can be a plain text file, XML data file, JSON data file, database file etc. The Job ticket also contains a section for the tracking information necessary for moving from one stage to another in the Process. Each Job Ticket generated is also assigned a unique identity that can be used in scenarios of “On Demand” processing by referring to it. Barcoding system is one of the ways to refer to such identity in on demand processing scenario. The others could be RFID etc.
(3) Stage and Process (Process Creator) —A Stage is an activity that is carried out as part of the manufacturing process to transform the input. A Stage will need its own data set, required to carry out the designated activity. The schema for this data is supplied by the user as part of the Stage definition. A Process is collection of these stages in the sequence of execution, representing the complete manufacturing.
(4) Job Ticket Generator—It is a console that allows user interaction and allows him to carry out the following—
   a. allow the user to define stages of processing by providing the name, location in the network and the data schema to be associated with each stage. It also allows the user to define a Process by giving it a name and associate Stages in sequence of their execution.
   b. Define and establish Data Connectors, one each for every order source.
   c. Generate Job Ticket automatically and push it into the apparatus for processing as soon as the order arrives.
(5) Postal Agent—A component that is responsible for moving a Job Ticket to its next destination based on the tracking information present inside the Job Ticket. It also provides update of the current status of the Job to the Control Panel as it moves the Job Ticket. There is a postal agent present at every stage in the process and at the job ticket generator console. Once, the job ticket generator hands over a Job Ticket to its Postal Agent, it continues to move from one stage to another, as the execution at that stage completes, until the completion of the Process.
(6) Job Ticket Server—It is a repository of Job tickets arriving at a stage. Its Job is to make a Job Ticket available, when a Processing Client will request for it. Once, the Job is completed, the Job Ticket is returned to it by the Processing Client along with the status of the Job. The Job Ticket Server then hands over the updated Job Ticket to its Postal Agent, who will then forward it to the next destination.
(7) Processing Clients—It is a terminal, where a machine or a service is present to process the incoming Job. The User can request the Job Ticket Server through this console for the Job Ticket corresponding to the incoming Job. This terminal is also connected to machine or a service defined as an End Point. It initiates the processing by placing a call to the End Point, along with the Job-related data as required.
(8) Configurable End Points—It is the terminal end of the processing client that is connected to a machine or a service or a combination responsible for processing the incoming Job. The type of machine or the service connected is completely unknown to the Workflow Automation apparatus, since the Process itself and the data associated with it is user defined to start with. Therefore, the end point provides a mechanism for configuration by the user. The user can provide a configuration that will process and connect the incoming Job-related data to the machine or service connected to it, for processing. Mechanism for such a configuration can be a Program script defined by the user, a simple port connection to transfer the Job data, a call to another process to handle the processing, WebSockets, HTTP transfer, Internet of Things (TOT) protocol etc. Such configuration allows machines completely unknown to the apparatus to be connected to it.
(9) Control Panel—It displays the status of the Jobs in the system at any given point in time. It also provides a mechanism to the person managing the production to control an individual Job, like pausing, removing, restarting the Job in case of Error etc. An optional interface can also be made available to the customers to query the status of their orders.

### Working of the Apparatus:

At the heart of the apparatus is the Job Ticket and network of Postal Agents. The Job Ticket is moved in an automated fashion by a network of postal agents that resides in the computers/devices serving the various stages of the workflow, over a data network utilizing the tracking information related to various stages of the workflow, embedded in the Job Ticket.

The workflow process itself can be defined by the user along with its tracking information, which is eventually made the part of the Job Ticket, when it is generated. The tracking information contains the complete network path, optional local file folders on the networked computers/devices associated with the stages, which the Job Ticket has to track as part of the workflow. The connected devices tracked by the Job Ticket can be present in the same or different but connected local area network (LAN), can be part of companywide manufacturing locations connected by metro area network (MAN) or wide area network (WAN) or Internet. As one stage is completed and notified to the Postal agent of that stage, the Job Ticket is forwarded to the Postal agent of the next stage in the workflow process automatically, ensuring the automation of the workflow.

As shown in the example job ticket structure above, each section in the Job Ticket, contains some data as defined by the end-user. There is one section that is mandatory and it is the workflow section that contains the tracking information. The name of this section can vary but in essence it contains the stages of the workflow process and the location of the networked devices and optional storage location in the networked device.

The name of the other various sections can be decided by the user himself and the data to be stored is also decided by the user based on the needs of the various stages of the workflow. This schema for the data to be stored, can be supplied by the user while defining the stage. An example of the data schema based on XML standard XSD format along with a sample data in XML for a material allocation stage used in a Garment decoration process is as below—

The number of stages and its relative execution order is defined by the process. Depending upon the actual customer order inputs, some stages may not be required to execute and therefore not present in the final Job Ticket created corresponding to the order. For example, a process definition may contain stages X and Y, but the customer order only included stage X. Therefore, the stage Y will be omitted from the Job Ticket finally generated.

Once the user has defined the stages of the workflow process, its tracking information and the schema/format of the data that is associated with each stage in the workflow, the data file template for the workflow is ready. This data file template serves as the basis of Job Ticket definition. Now, the user can define the mapping of the data fields in the data file template to the actual data sources. The data sources could be any database, input by the user from the keyboard, input file, cloud sources etc. Such mapping of the data fields in the workflow data template, together with the linkages to the data sources is referred to as a data connector.

Once the Data Connector is defined, the workflow is ready for execution using the network of postal agents that resides in the devices/computers associated with each stage of the workflow process. Using the data connector, the order data is sourced from the corresponding data sources and an actual job ticket is generated for execution at the beginning stage of the workflow. As this job ticket moves along various stages of the workflow Process, each stage generates the data after processing and stores it in this Job Ticket. This Job Ticket then becomes the dynamic storage for data generated by the stages of the workflow. After the last stage of the workflow process, the job ticket has all the data generated by the execution of the workflow Process. This data can be extracted from the Job Ticket using the similar data mappings used in the beginning of the workflow process to fetch the data from the order data store, but this time in reverse direction to store the processed data back into the data sources. This data sourcing and storing at both the terminal ends of the workflow process can be complimented by programming scripts that user can define using the data fields in order to condition and qualify the data before use.

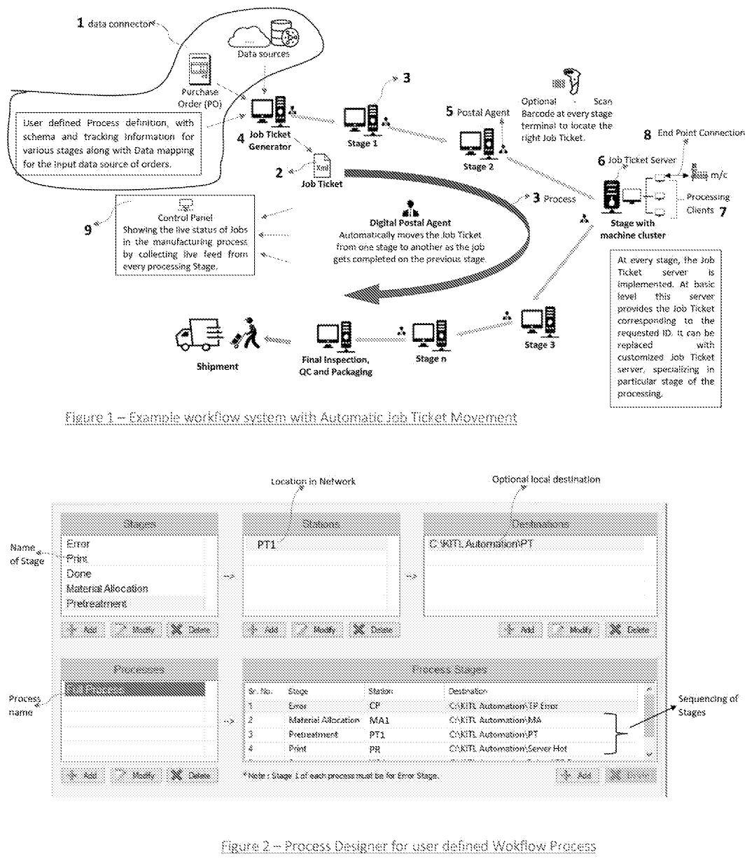

In the embodiment of the present invention FIGS. 1, 2, 3 and 4 illustrates various components of the Workflow Automation and their collaboration.

FIG. 1 illustrates typical workflow along with the various components of the apparatus.

FIG. 2 illustrates the Process creator for User defined workflow Process. An example process for Garment Decoration called “Full Process” is shown created in the Figure, consisting of Material Allocation, Pre-treatment and Print Stages. The Material Allocation stage is located at computer named M1 in the network. The Pre-treatment stage is located at computer named PT1 in the network and the Print Stage is located at computer named PR in the network.

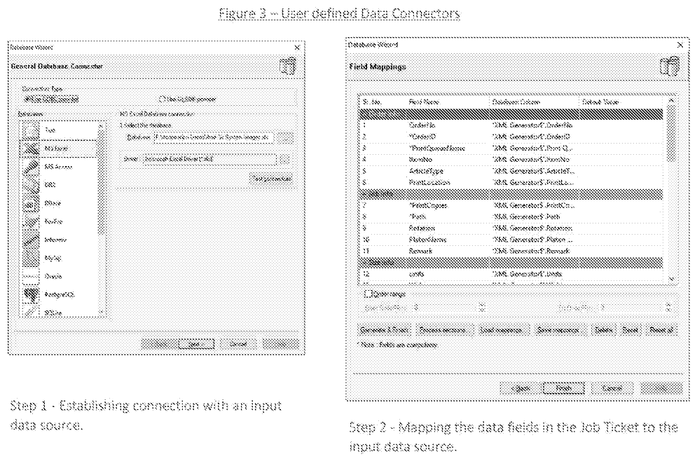

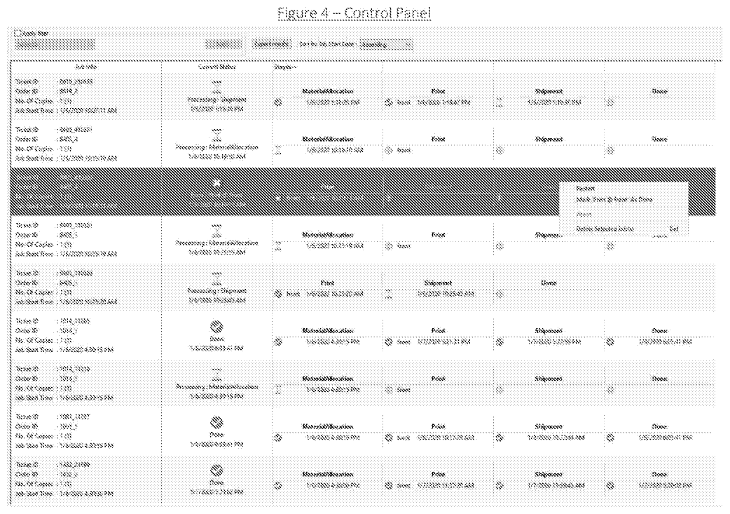

FIG. 3 illustrates how the user can define the Data Connectors. An example data connection is shown established with the Excel database and mappings created to link this data to fields in Job ticket. A Data Connector that created can be used to automatically generate the Job Ticket based on incoming order data.

FIG. 4 illustrates a Control Panel showing the progress update of various Jobs in the workflow along with various control it offers over a Job.

Each of the Job Ticket can be tagged/named using a unique ID/name, which can be barcoded. By scanning the barcode, the specific Job Ticket can be recalled in an OnDemand process. The apparatus can also automatically process the Job Tickets that are not barcoded for OnDemand processing. The Postal agents are networking software that assumes role of a Server and a client over the network, accepting incoming Job Tickets (server) and posting them to the destination on the local storage. They also check for the Job Tickets that has been processed by the associated stage and move them to next stage (client) by establishing the communication with the Postal agent associated with the next stage in the workflow. The Postal agents also provide live feed to a Control Panel as the job progresses. The Control Panel shows the progress at a glance at any given instance. Customers can also contact the Control Panel through an optional interface to track the progress of their orders by providing the Order identification.

At the devices/computers associated with the various stages, there is a Job Ticket server. It makes the requested Job Ticket (stage data) available to any device/Processing Client connected to it, upon request. Such specific file is identified based on the ID supplied or next in queue as requested by the device. Once, the requesting device has processed the Job Ticket, it can post the Job Ticket back to the Job Ticket Server, which will in turn hand it over to the Postal agent. The Postal agent will move it to next stage in the workflow process. This generic behavior of the Job Ticket server can be replaced by a more specialized Job Ticket server depending upon the need of the processing stage. However, the underlying concept remains the same, i.e., to provide the specific Job Ticket on demand for processing.

At the terminal end of the Processing clients are the services/machines required to process the input according to the Job ticket. These services or machines connect to the apparatus through End Point Configuration mechanism, which provides for the connectivity and control of the machine or service or their combination for input processing. Example of a service at an End Point could be shipment booking Web service by the logistics service provider. Example of machine at the End Point could be a Printing Machine for printing a garment.

This apparatus can involve either the human interaction with the devices or the devices talking to each other in the workflow or a combination of both.

As can be seen, the apparatus is fully configurable by the end user to meet with his/her own needs of the workflow. The apparatus sets in motion the automatic movement of the Job ticket (which depending upon the context can be named differently without having any material impact on the purpose of it) through the various stages of the workflow in sequence as decided by the user.

### Preferred Embodiment

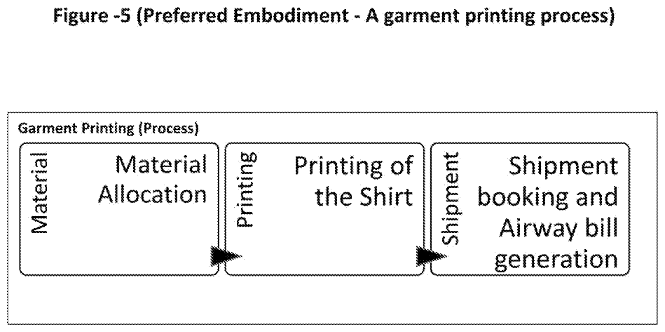

Let's consider a scenario, where in a production process, a Garment is decorated by printing. Each garment is uniquely decorated by the artwork supplied by the customer in an On-Demand production scenario.
If the process is named as “Garment Printing”, the process looks as follows: —
A. Process—Garment Printing
B. Stages—Material Allocation>>Printing>>Shipment. Definition defined using the process creator interface as shown in FIG. 5.
C. The Schema for the individual Stages in XML XSD specification is as follows—
1. Media Allocation.

```
<?xml version=″1.0″ standalone=″yes″?>
<NewDataSet>
  <xs:schema id=″NewDataSet″ xmlns=″″ xmlns:xs=″http://www.w3.org/2001/XMLSchema″
xmlns:msdata=″urn:schemas-microsoft-com:xml-msdata″>
  <xs:element name=″NewDataSet″ msdata:IsDataSet=″true″ msdata:UseCurrentLocale=″true″>
      <xs:complexType>
      <xs:choice minOccurs=″0″ maxOccurs=″unbounded″>
      <xs:element name=″MaterialAllocation″>
    <xs:complexType>
      <xs:sequence>
        <xs:element name=″Brand″ type=″xs:string″ minOccurs=″0″ maxOccurs=″1″ />
        <xs:element name=″PartNumber″ type=″xs:string″ minOccurs=″0″ maxOccurs=″1″ />
        <xs:element name=″Color″ type=″xs:string″ minOccurs=″0″ maxOccurs=″1″ />
        <xs:element name=″Size″ type=″xs:string″ minOccurs=″0″ maxOccurs=″1″ />
      </xs:sequence>
    </xs:complexType>
  </xs:element>
  </xs:choice>
    </xs:complexType>
  </xs:element>
  </xs:schema>
  <MaterialAllocation>
    <Brand>Aone</Brand>
    <PartNumber>AD1</PartNumber>
    <Color>Red</Color>
    <Size>XL</Size>
  </MaterialAllocation>
</NewDataSet>
```

### 2. Printing.

```
<?xml version=″1.0″ standalone=″yes″?>
<NewDataSet>
  <xs:schema id=″NewDataSet″ xmlns=″″ xmlns:xs=″http://www.w3.org/2001/XMLSchema″
xmlns:msdata=″urn:scherms-microsoft-com:xml-msdata″>
  <xs:element name=″NewDataSet″ msdata:IsDataSet=″true″ msdata:UseCurrentLocale=″true″>
    <xs:complexType>
      <xs:choice minOccurs=″0″ maxOccurs=″unbounded″>
      <xs:element name=″Print″>
      <xs:complexType>
      <xs:sequence>
      <xs:element name=″JobPrintPriority″ type=″xs:positiveInteger″ minOccurs=″0″ maxOccurs=″1″ />
      <xs:element name=″AbortOnError″ type=″xs:boolean″ minOccurs=″0″ maxOccurs=″1″ />
      <xs:element name=″PrintQueueName″ type=″xs:string″ minOccurs=″0″ maxOccurs=″1″ />
      <xs:element name=″DeleteSourceImageAfterPrint″ type=″xs:boolean″ minOccurs=″0″ maxOccurs=″1″ />
      <xs:element name=″PrintLocation″ type=″xs:string″ minOccurs=″0″ maxOccurs=″1″ />
      <xs:element name=″PRINT_JOB_INFO″>
    <xs:complexType>
      <xs:sequence>
      <xs:element name=″Remark″ type=″xs:string″ minOccurs=″0″ maxOccurs=″1″ />
      <xs:element name=″RipConstraint″ type=″xs:boolean″ minOccurs=″0″ maxOccurs=″1″ />
      <xs:element name=″Path″ type=″xs:string″ minOccurs=″0″ maxOccurs=″1″ />
      <xs:element name=″Rotation″ type=″xs:float″ minOccurs=″0″ maxOccurs=″1″ />
      <xs:element name=″PlatenName″ type=″xs:string″ minOccurs=″0″ maxOccurs=″1″ />
      <xs:element name=″Size″ minOccurs=″0″ maxOccurs=″1″>
        <xs:complexType>
        <xs:sequence>
          <xs:element name=″Type″ type=″xs:string″ minOccurs=″0″ maxOccurs=″1″ />
          <xs:element name=″Width″ type=″xs:float″ minOccurs=″0″ maxOccurs=″1″ />
          <xs:element name=″Height″ type=″xs:float″ minOccurs=″0″ maxOccurs=″1″ />
        </xs:sequence>
          <xs:attribute name=″units″ type=″xs:string″ />
        </xs:complexType>
        </xs:element>
        <xs:element name=″Position″ minOccurs=″0″ maxOccurs=″1″>
      <xs:complexType>
      <xs:sequence>
        <xs:element name=″Type″ type=″xs:string″ minOccurs=″0″ maxOccurs=″1″ />
        <xs:element name=″X″ type=″xs:float″ minOccurs=″0″ maxOccurs=″1″ />
        <xs:element name=″Y″ type=″xs:float″ minOccurs=″0″maxOccurs=″1″ />
        </xs:sequence>
          <xs:attribute name=″units″ type=″xs:string″ />
          </xs:complexType>
          </xs:element>
          <xs:element name=″InkType″ type=″xs:string″ minOccurs=″0″ maxOccurs=″1″ />
          <xs:element name=″MediaType″ type=″xs:string″ minOccurs=″0″ maxOccurs=″1″ />
          <xs:element name=″PrintingBackground″ type=″xs:string″ minOccurs=″0″ maxOccurs=″1″ />
          <xs:element name=″BrandName″ type=″xs:string″ minOccurs=″0″ maxOccurs=″1″ />
          <xs:element name=″PartNumber″ type=″xs:string″ minOccurs=″0″ maxOccurs=″1″ />
          <xs:element name=″ColorName″ type=″xs:string″ minOccurs=″0″ maxOccurs=″1″ />
          <xs:element name=″SupportNCSB″ type=″xs:boolean″ minOccurs=″0″ maxOccurs=″1″ />
          <xs:element name=″NCSB″ type=″xs:string″ minOccurs=″0″ maxOccurs=″1″ />
          <xs:element name=″ExcludeColorsName″ type=″xs:string″ minOccurs=″0″ maxOccurs=″1″ />
          <xs:element name=″ExcludeColorsRGB″ type=″xs:string″ minOccurs=″0″ maxOccurs=″1″ />
          <xs:element name=″ExcludeColorsCMYK″ type=″xs:string″ minOccurs=″0″ maxOccurs=″1″ />
          <xs:element name=″ExcludeColorsLAB″ type=″xs:string″ minOccurs=″0″ maxOccurs=″1″ />
          <xs:element name=″AdvanceColorControl″>
        <xs:complexType>
          <xs:sequence>
          <xs:element name=″PrintingColorBooster″ type=″xs:string″ minOccurs=″0″ maxOccurs=″1″ />
          </xs:element>
          <xs:element name=″PrintingStrength″ type=″xs:string″ minOccurs=″0″ maxOccurs=″1″ />
          </xs:sequence>
        </xs:complexType>
    </xs:element>
    <xs:element name=″UnderbaseStrength″ type=″xs:float″ minOccurs=″0″ maxOccurs=″1″ />
    <xs:element name=″HighlightStrength″ type=″xs:float ″minOccurs=″0″ maxOccurs=″1″ />
    <xs:element name=″HighlightGeneratorType″ type=″xs:string″ minOccurs=″0″ maxOccurs=″1″ />
    <xs:element name=″HighlightFuzziness″ type=″xs:float″ minOccurs=″0″ maxOccurs=″1″ />
    </xs:sequence>
    </xs:complexType>
    </xs:element>
    </xs:sequence>
    </xs:complexType>
    </xs:element>
    </xs:choice>
    </xs:complexType>
    </xs:element>
    </xs:schema>
  <Print>
    <JobPrintPriority>3</jobPrintPriority>
    <AbortOnError>true</AbortOnError>
    <PrintQueueName>Queue 1</PrintQueueName>
    <DeleteSourceImageAfterPrint>true</DeleteSourceImageAfterPrint>
    <PrintLocation>Front</PrintLocation>
    <PRINT_JOB_INFO>
      <Remark>Hello</Remark>
      <RipConstraint>true</RipConstraint>
      <Path>C:\KITL Automation\Server Images\Order11_20190710091924173.png</Path>
      <Rotation>5.0</Rotation>
      <PlatenName>ISO A4</PlatenName>
      <Size units=″inch″>
        <Type>Custom</Type>
        <Width>3.000</Width>
        <Height>4.000</Height>
      </Size>
      <Position units=″inch″>
        <Type>Custom</Type>
        <X>0.000</X>
        <Y>0.000</Y>
      </Position>
      <InkType>Default Ink<InkType>
      <MediaType>Generic Media</MediaType>
      <PrintingBackground>Black</PrintingBackground>
      <BrandName>Generic Brand</BrandName>
      <PartNumber>3720a_005</PartNumber>
      <ColorName>Black</ColorName>
      <SupportNCSB>true</SupportNCSB>
      <NCSB>3720A-005</NCSB>
      <ExcludeColorsName>Dark Green_CNST_A0QE_343</ExcludeColorsName>
      <ExcludeColorsRGB></ExcludeColorsRGB>
      <ExcludeColorsCMYK></ExcludeColorsCMYK>
      <ExcludeColorsLAB></ExcludeColorsLAB>
      <AdvanceColorControl>
        <PrintingColorBooster>1.000</PrintingColorBooster>
        <PrintingColorStrength>2.000</PrintingColorStrength>
      </AdvanceColorControl>
      <UnderbaseStrength>5.000<UnderbaseStrength>
      <HighlightStrength>6.000<HighlightStrength>
      <HighlightGeneratorType>Combine<HighlightGeneratorType>
      <HighlightFuzziness>7.000</HighlightFuzziness>
    </PRINT_JOB_INFO>
  </Print>
</NewDataSet>
```

### 3. Shipment.

```
<?xml version=″1.0″ standalone=″yes″?>
<NewDataSet>
  <xs:schema id=″NewDataSet″ xlmns=″″ xlmns:xs=″http://www.w3.org/2001/XMLSchema″
xmlns:msdata=″urn:schemas-microsoft-com:xml-msdata″>
  <xs:element name=″NewDataSet″ msdata:IsDataSet=″true″ msdata:UseCurrentLocale=″true″>
    <xs:complexType>
      <xs:choice minOccurs=″0″ maxOccurs=″unbounded″>
      <xs:element name=″Shipment″>
        <xs:complexType>
          <xs:sequence>
          <xs:element name=″Carrier″ type=″xs:string″ minOccurs=″0″ maxOccurs=″1″ />
          <xs:element name=″ShipmentType″ type=″xs:string″ minOccurs=″0″ maxOccurs=″1″ />
          <xs:element name=″WeightUnit″ type=″xs:string″ minOccurs=″0″ maxOccurs=″1″ />
          <xs:element name=″WeightValue″ type=″xs:float″ minOccurs=″0″ maxOccurs=″1″ />
          <xs:element name=″Remarks″ type=″xs:string″ minOccurs=″0″ maxOccurs=″1″ />
          <xs:element name=″R_PersonName″ type=″xs:string″ minOccurs=″0″ maxOccurs=″1″ />
          <xs:element name=″R_CompanyName″ type=″xs:string″ minOccurs=″0″ maxOccurs=″1″ />
          <xs:element name=″R_phoneNumber″ type=″xs:string″ minOccurs=″0″ maxOccurs=″1″ />
          <xs:element name=″R_EmailID″ type=″xs:string″ minOccurs=″0″ maxOccurs=″1″ />
          <xs:element name=″R_AddressLine1″ type=″xs:string″ minOccurs=″0″ maxOccurs=″1″ />
          <xs:element name=″R_AddressLine2″ type=″xs:string″ minOccurs=″0″ maxOccurs=″1″ />
          <xs:element name=″R_CityName″ type=″xs:string″ minOccurs=″0″ maxOccurs=″1″ />
          <xs:element name=″R_StateOrProvinceCode″ type=″xs:string″ minOccurs=″0″ maxOccurs=″1″ />
          <xs:element name=″R_PostalCode″ type=″xs:string″ minOccurs=″0″ maxOccurs=″1″ />
          <xs:element name=″R_CountryCode″ type=″xs:string″ minOccurs=″0″ maxOccurs=″1″ />
          <xs:element name=″Length″ type=″xs:float″ minOccurs=″0″ maxOccurs=″1″ />
          <xs:element name=″Height″ type=″xs:float″ minOccurs=″0″ maxOccurs=″1″ />
          <xs:element name=″Width″ type=″xs:float″ minOccurs=″0″ maxOccurs=″1″ />
          <xs:element name=″DimUnit″ type=″xs:string″ minOccurs=″0″ maxOccurs=″1″ />
          <xs:element name=″QtyToShip″ type=″xs:positiveInteger″ minOccurs=″0″ maxOccurs=″1″ />
          <xs:element name=″TotalPrice″ type=″xs:float″ minOccurs=″0″ maxOccurs=″1″ />
          <xs:element name=″Currency″ type=″xs:string″ minOccurs=″0″ maxOccurs=″1″ />
          <xs:element name=″CustomDescription″ type=″xs:string″ minOccurs=″0″ maxOccurs=″1″ />
          <xs:element name=″JobFetchDate″ type=″xs:string″ minOccurs=″0″ maxOccurs=″1″ />
          <xs:element name=″JobFetchTime″ type=″xs:string″ minOccurs=″0″ maxOccurs=″1″ />
          <xs:element name=″UnitPrice″ type=″xs:float″ minOccurs=″0″ maxOccurs=″1″ />
          <xs:element name=″TotalTipReceived″ type=″xs:float″ minOccurs=″0″ maxOccurs=″1″ />
          <xs:element name=″LineItemID″ type=″xs:string″ minOccurs=″0″ maxOccurs=″1″ />
          <xs:element name=″ShopifyOrderID″ type=″xs:string″ minOccurs=″0″ maxOccurs=″1″ />
          <xs:element name=″LocationID″ type=″xs:string″ minOccurs=″0″ maxOccurs=″1″ />
          <xs:element name=″FulfillmentService″ type=″xs:string″ minOccurs=″0″ maxOccurs=″1″ />
          <xs:element name=″SourceofJob″ type=″xs:string″ minOccurs=″0″ maxOccurs=″1″ />
          <xs:element name=″Return_PersonName″ type=″xs:string″ minOccurs=″0″ maxOccurs=″1″ />
          <xs:element name=″Return_CompanyName″ type=″xs:string″ minOccurs=″0″ maxOccurs=″1″ />
          <xs:element name=″Return_phoneNumber″ type=″xs:string″ minOccurs=″0″ maxOccurs=″1″ />
          <xs:element name=″Return_EmailID″ type=″xs:string″ minOccurs=″0″ maxOccurs=″1″ />
          <xs:element name=″Return_AddressLine1″ type=″xs:string″ minOccurs=″0″ maxOccurs=″1″ />
          <xs:element name=″Return_AddressLine2″ type=″xs:string″ minOccurs=″0″ maxOccurs=″1″ />
          <xs:element name=″Return_CityName ″type=″xs:string ″minOccurs=″0 ″maxOccurs=″1 ″/>
          <xs:element name=″Return_StateOrProvinceCode″ type=″xs:string″ minOccurs=″0″ maxOccurs=″1″ />
          <xs:element name=″Return_PostalCode″ type=″xs:string″ minOccurs=″0″ maxOccurs=″1″ />
          <xs:element name=″Return_CountryCode″ type=″xs:string″ minOccurs=″0″ maxOccurs=″1″ />
          </xs:sequence>
        </xs:complexType>
      </xs:element>
    </xs:choice>
      </xs:complexType>
      </xs:element>
    </xs:schema>
  <Shipment>
    <Carrier>USPS</Carrier>
    <ShipmentType>Express</ShipmentType>
    <WeightUnit>LB</WeightUnit>
    <WeightValue>0.35</WeightValue>
    <Remarks>ASAP</Remarks>
    <R_PersonName>Lucifer Morningstart</R_PersonName>
    <R_CompanyName>XYZ</R_CompanyName>
    <R_phoneNumber>+19999999999</R_phoneNumber>
    <R_EmailID>abc.xyz@pqr.com</R_EmailID>
    <R_AddressLine1>1100 Valencia Avenue</R_AddressLine1>
    <R_AddressLine2>Building2</R_AddressLine2>
    <R_CityName>Tustin</R_CityName>
    <R_StateOrProvinceCode>CA</R_StateOrProvinceCode>
    <R_PostalCode>92780</R_PostalCode>
    <R_CountryCode>US</R_CountryCode>
    <Length>12</Length>
    <Height>14</Height>
    <Width>13</Width>
    <DimUnit>IN</DimUnit>
    <QtyToShip>1</QtyToShip>
    <TotalPrice>15.0</TotalPrice>
    <Currency>USD</Currency>
    <CustomDescription>TShirt</CustomDescription>
    <JobFetchDate>10_17_2019</JobFetchDate>
    <JobFetchTime>11_36_23_1234</JobFetchTime>
    <UnitPrice>0.0</UnitPrice>
    <TotalTipReceived>0.0</TotalTipReceived>
    <LineItemID>123345</LineItemID>
    <ShopifyOrderID>12345</ShopifyOrderID>
    <LocationID>12345</LocationID>
    <FulfillmentService>Oberlo</FulfillmentService>
    <SourceofJob>Shopify</SourceofJob>
    <Return_PersonName>Lucifer Morningstart</Return_PersonName>
    <Return_CompanyName>XYZ</Return_CompanyName>
    <Return_phoneNumber>+19999999999</Return_phoneNumber>
    <Return_EmailID>abc.xyz@pqr.com</Return_EmailID>
    <Return_AddressLine1>1100 Valencia Avenue</Return_AddressLine1>
    <Return_AddressLine2>Building2</Return_AddressLine2>
    <Return_CityName>Tustin</Return_CityName>
    <Return_StateOrProvinceCode>CA</Return_StateOrProvinceCode>
    <Return_PostalCode>92780</Return_PostalCode>
    <Return_CountryCode>US</Return_CountryCode>
  </Shipment>
</NewDataSet>
```

D. The input order data in XML format is as below—

```
<?xml version=″1.0″encoding=″UTF-8″?>
<Orders>
  <Order>
    <OrderNo>8951</OrderNo>
    <OrderID>Order_8951</OrderID>
    <ItemNo>10922 /ItemNo>
    <ArticleType>Tshirt</ArticleType>
    <ArticleLocation>front</ArticleLocation>
    <TrackingProcessSelection>Simplified</TrackingProcessSelection>
    <PrintCopies>1</PrintCopies>
    <PrintQueue>Queue 3</PrintQueue>
    <Path>https:// windows.net/ print-files/10922_2020-01-08-08_46_04_219807.png</Path>
    <PlatenName>Shirtboard 34x28</PlatenName>
    <InkType>Default Ink<InkType>
    <MediaType>Generic Media</MediaType>
    <PrintingBackground>Black</PrintingBackground>
    <BrandName>Generic Brand</BrandName>
    <PartName>SS Black Media 3-3</PartName>
    <ColorName>Black</ColorName>
    <SizeType>AsInDoc</SizeType>
    <Width>0</Width>
    <Height>0</Height>
    <Units</Units>
    <Position>Center</Position>
    <X>0</X>
    <Y>0</Y>
    <Color>Black</Color>
    <Size>2XL</Size>
    <Brand>Gildan</Brand>
    <PSIN>gildan-18500-black-2xl</PSIN>
    <ShipmentType/>
    <WeightUnit>oz</WeightUnit>
    <WeightValue>5</WeightValue>
    <Remarks/>
    <NoOfPieces>1</NoOfPieces>
    <S_PersonName>Abc Xyz</S_PersonName>
    <S_CompanyName/>
    <S_PhoneNumber/>
    <S_AddressLine1>Abc BRIARTRACE CT</S_AddressLine1>
    <S_AddressLine2/>
    <S_CityName>HOUSTON</S_CityName>
    <S_StateOrProvinceCode>TX</S_StateOrProvinceCode>
    <S_PostalCode>77044</S_PostalCode>
    <S_CountryCode>US</S_CountryCode>
    <S_Email/>
    <R_PersonName>Pqr Efg</R_PersonName>
    <R_CompanyName/>
    <R_PhoneNumber/>
    <R_AddressLine1>400 Treat Ave</R_AddressLine1>
    <R_AddressLine2>Suite G</R_AddressLine2>
    <R_CityName>San Francisco</R_CityName>
    <R_StateOrProvinceCode>CA</R_StateOrProvinceCode>
    <R_PostalCode>94110</R_PostalCode>
    <QtyToShip>1</QtyToShip>
    <TotalPrice>15</TotalPrice>
    <R_CountryCode>US</R_CountryCode>
    <TinType/>
    <TinNumber/>
    <Currency/>
    <Amount/>
    <UnitPrice/>
    <ShipLength/>
    <ShipHeight/>
    <ShipWidth/>
    <DimUnit/>
    <CountryRelationship/>
    <ShippingLabelURL/>
  </Order>
</Orders>
```

E. A mapping is defined for Order Data in (D) to Process Schema in (C), using the data connector interface shown in FIG. 3. The Job Ticket in XML format, generated after mapping the Order data (D) to Process Schema (C) is as below—

```
<?xml version=″1.0″ encoding=″utf-8″?>
<JobTicket>
  <TrackingInfo>
    <TrackingInfoVersion>1</TrackingInfoVersion>
    <ProcessName>Simplified</ProcessName>
    <TotalSteps>5</TotalSteps>
    <Step1>
      <Name>Error</Name>
      <Host>KITL1</Host>
    </Step1>
    <Step2>
      <Name>MaterialAllocation</Name>
      <Host>KITL2</Host>
    </Step2>
    <Step3>
      <Name>Print @ front</Name>
      <Host>KITL2</Host>
    </Step3>
    <Step4>
      <Name>Shipment</Name>
      <Host>KITL2</Host>
    </Step4>
    <Step5>
      <Name>Done</Name>
      <Host>KITL1</Host>
    </Step5>
    <SourceStation>KITL1</SourceStation>
    <CurrentStep>2</CurrentStep>
    <NextStep>2</NextStep>
    <PreviousStep>0</PreviousStep>
    <LastStatusCode>0</LastStatusCode>
  </TrackingInfo>
  <ProcessInfo>
    <ProcessName>Simplified</ProcessName>
    <TotalSteps>5</TotalSteps>
    <Step1>
      <Name>Error</Name>
      <Host>KITL1</Host>
    </Step1>
    <Step2>
      <Name>MaterialAllocation</Name>
      <Host>KITL2</Host>
    </Step2>
    <Step3>
      <Name>Print</Name>
      <Host>KITL2</Host>
    </Step3>
    <Step4>
      <Name>Shipment</Name>
      <Host>KITL2</Host>
    </Step4>
    <Step5>
      <Name>Done</Name>
      <Host>KITL1</Host>
    </Step5>
  </ProcessInfo>
  <ReportingInfo>
    <ReportingStationVersion>1</ReportingStationVersion>
    <ReportingStation>KITL1</ReportingStation>
    <ReportingFolder>C:\KITL Automation\TP Hot</ReportingFolder>
  </ReportingInfo>
  <GlobalInfo>
    <OriginalPrintID>8951_810922</OriginalPrintID>
    <OriginalTotalCopies>1</OriginalTotalCopies>
    <TotalCopies>1</TotalCopies>
    <CopyNumbers>1</CopyNumbers>
    <OrderID>8951_8</OrderID>
    <ItemNo>10922</ItemNo>
    <BarcodeGenerationType>0</BarcodeGenerationType>
    <BarcodeGenerationSeparator>#</BarcodeGenerationSeparator>
    <ArticleInfo>
      <ArticleType>Tshirt</ArticleType>
      <PrintLocation>front</PrintLocation>
    </ArticleInfo>
    <OrderInfo>
      <OrderData>
        <OrderNo>8951</OrderNo>
        <OrderID>Order_8951</OrderID>
        <ItemNo>10922<ItemNo>
        <ArticleType>Tshirt</ArticleType>
        <ArticleLocation>front</ArticleLocation>
        <TrackingProcessSelection>Simplified</TrackingProcessSelection>
        <PrintCopies>1</PrintCopies>
        <PrintQueue>Queue 3</PrintQueue>
        <Path>https://windows.net/print-files/10922_2020-01-08-08_46_04_219807.png</Path>
        <PlatenName>Shirtboard 34x28</PlatenName>
        <InkType>Default Ink</InkType>
        <MediaType>Generic Media</MediaType>
        <PrintingBackground>Black</PrintingBackground>
        <BrandName>Generic Brand</BrandName>
        <PartName>SS Black Media 3-3</PartName>
        <ColorName>Black</ColorName>
        <SizeType>AsInDoc</SizeType>
        <Width>0</Width>
        <Height>0</Height>
        <Units>inch</Units>
        <Position>Center</Position>
        <X>0</X>
        <Y>0</Y>
        <Color>Black</Color>
        <Size>2XL</Size>
        <Brand>Gildan</Brand>
        <PSIN>gildan-18500-black-2x1</PSIN>
        <WeightUnit>oz</WeightUnit>
        <WeightValue>5</WeightValue>
        <NoOfPieces>1</NoOfPieces>
        <S_PersonName>Abc Xyz</S_PersonName>
        <S_AddressLine1>Abc BRIARTRACE CT</S_AddressLine1>
        <S_CityName>HOUSTON</S_CityName>
        <S_StateOrProvinceCode>TX</S_StateOrProvinceCode>
        <S_PostalCode>77044</S_PostalCode>
        <S_CountryCode>US</S_CountryCode>
        <QtyToShip>1</QtyToShip>
        <TotalPrice>15</TotalPrice>
        <R_PersonName>Pqr Efg</R_PersonName>
        <R_AddressLine1>400 Treat Ave</R_AddressLine1>
        <R_AddressLine2>Suite G</R_AddressLine2>
        <R_CityName>San Francisco</R_CityName>
        <R_StateOrProvinceCode>CA</R_StateOrProvinceCode>
        <R_PostalCode>94110</R_PostalCode>
        <R_CountryCode>US<R_CountryCode>
      </OrderData>
    </OrderInfo>
    <PrintID>8951_810922front</PrintID>
  </GlobalInfo>
  <JobSheet>
    <PrintLocation>front</PrintLocation>
    <Image>https://windows.net/print-files/10922_2020-01-08-08_46_04_219807.png</Image>
    <PlatenName>2XL</PlatenName>
    <Width>0</Width>
    <Height>0</Height>
    <Position>Center</Position>
    <X>1</X>
    <Y>0</Y>
    <InkType>gildan-18500-black-2xl</InkType>
    <MediaType>Generic Media</MediaType>
    <PrintingBkg>Black</PrintingBkg>
    <BrandName>Hoodie</BrandName>
    <PartNumber>8951</PartNumber>
    <ColorName>Black</ColorName>
  </JobSheet>
  <Step2>
    <Brand>Gildan</Brand>
    <PartNumber>gildan-18500-black-2xl</PartNumber>
    <Color>Black</Color>
    <Size>2XL</Size>
  </Step2>
  <Step3>
    <PrintQueueName>Queue 3</PrintQueueName>
    <DeleteSourceImageAfterPrint>Yes</DeleteSourceImageAfterPrint>
    <PrintLocation>front</PrintLocation>
    <PRINT_JOB_INFO>
      <Path Resource=″C:\ KITL Automation\Server Images\8951_810922front_20200108004623317.png″
SourceStation=″KITL1″>https://windows.net/print-files/10922_2020-01-08-08_46_04_219807.png</Path>
      <PlatenName>Shirtboard 34x28</PlatenName>
      <InkType>Default Ink</InkType>
      <MediaType>Generic Media</MediaType>
      <PrintingBackground>Black</PrintingBackground>
      <BrandName>Generic Brand</BrandName>
      <PartNumber>SS Black Media 3-3</PartNumber>
      <ColorName>Black</ColorName>
      <Size units=″inch″>
        <Type>BestFitAsInDoc</Type>
        <Width>0</Width>
        <Height>0</Height>
      </Size>
      <Position units=″inch″>
        <Type>Center</Type>
        <X>1</X>
        <Y>0</Y>
      </Position>
    </PRINT_JOB_INFO>
  </Step3>
  <ShipDirect>
    <LineItemID>10922</LineItemID>
    <GenericOrderID>Order_8951</GenericOrderID>
    <SourceofJob>FTP</SourceofJob>
  </ShipDirect>
  <Step4>
    <WeightUnit>oz</WeightUnit>
    <WeightValue>15</WeightValue>
    <R_PersonName>Abc Xyz</R_PersonName>
    <R_AddressLine1>Abc BRIARTRACE CT</R_AddressLine1>
    <R_CityName>HOUSTON</R_CityName>
    <R_StateOrProvinceCode>TX</R_StateOrProvinceCode>
    <R_PostalCode>77044</R_PostalCode>
    <R_CountryCode>US</R_CountryCode>
    <QtyToShip>1</QtyToShip>
    <TotalPrice>15</TotalPrice>
    <CustomDescription>Tshirt</CustomDescription>
    <JobFetchDate>1_8_2020</JobFetchDate>
    <JobFetchTime>0_46_23_539</JobFetchTime>
    <UnitPrice>−1.0<UnitPrice>
    <TotalTipReceived>0.0</TotalTipReceived>
    <LineItemID>10922</LineItemID>
    <ShopifyOrderID>Order_8951</ShopifyOrderID>
    <FulfillmentService>Printforia</FulfillmentService>
    <SourceofJob>FTP_V1</SourceofJob>
    <Return_PersonName>Pqr Efg</Return_PersonName>
    <Return_EmailID>abe@printforia.com</Return_EmailID>
    <Return_AddressLine1>400 Treat Ave</Return_AddressLine1>
    <Return_AddressLine2>Suite G =/Return_AddressLine2>
    <Return_CityName>San Francisco</Return_CityName>
    <Return_StateOrProvinceCode>CA</Return_StateOrProvinceCode>
    <Return_PostalCode>94110</Return_PostalCode>
    <Return_CountryCode>US</Return_CountryCode>
  </Step4>
  <LICENSE_INFO>
    <Application>Kothari XML Generator</Application>
    <StationInfo>KITL1 - test - _DEMO_0422_</StationInfo>
    <SoftwareVersion>Version 7.1.0.2 - Build 7102v07 (7102v07) (Date : Jan 02 13:22, 2020)</SoftwareVersion>
    <LicenseDateTimeInfo>2020-01-08 00:46:23</LicenseDateTimeInfo>
    <LicenseVersion>1<LicenseVersion>
    <LicenseCode>fb83c655ee2843b08cc7ae4b4cf45024803a0e3a173e1afacd58b6170204</LicenseCode>
  </LICENSE_INFO>
</JobTicket>
```

F. This Job Ticket is moved through every Stage in the Process, in the sequence as defined by the Process. At every Stage, corresponding End Points Configuration are executed. The End Points in this example are programmed through Program Scripts. The Scripts are as shown below—

### 1. Material Allocation—

```
fnGetMaterial( Data in JobTicket/Step2 )
{
  // 1. Find the location in the Warehouse where the garments
are stored.
  // 2. Pick the quantities required and deduct from the inventory
database.
  // 3. Mark the quantities “in process” in inventory database.
  // 4. Put the barcode labels on the garment to identify the Job.
}
```

### 2. Printing—

```
fnPrint ( Data in JobTicket/Step3 )
{
  // Transfer the data to the printer and ask it to print.
  // mark the job done, update the ticket with quantity of ink
used.
}
```

### 3. Shipment—

```
fnBookShipment ( Data in JobTicket/Step4 )
{
  // 1. Pack the Garments and measure the weight.
  //2. Connect with USPS, provide the destination address and
book the shipment.
}
```

G. As can be seen once the Job progresses through the various Process Stages, it gets completed and Shipped. The End Points at various stages are configurable through program scripts, making it possible to be completely defined by the user, without having any prior knowledge of the services and machines involved.
H. The final Job Ticket after completion of the process looks as below—

```
<?xml version=″1.0″ encoding=″utf-8″?>
<JobTicket>
  <TrackingInfo>
    <TrackingInfoVersion>1</TrackingInfoVersion>
    <ProcessName>Simplified</ProcessName>
    <TotalSteps>5</TotalSteps>
    <Step1>
      <Name>Error</Name>
      <Host>KITL1</Host>
    </Step1>
    <Step2>
      <Name>MaterialAllocation</Name>
      <Host>KITL2</Host>
    </Step2>
    <Step3>
      <Name>Print @ front</Name>
      <Host>KITL2</Host>
      <OUTPUT_STATUS>
        <CopyDetail>
          <CopyNo>1</CopyNo>
          <DetailStatus>
            <PrintID>8951_810922front</PrintID>
            <OutputStatusCode>1</OutputStatusCode>
            <OutputStatusMessage>OK</OutputStatusMessage>
            <PrinterModel>Aeoon</PrinterModel>
            <PrinterName>Aeoon</PrinterName>
            <SoftwareVerson>Version 7.1.0.2 - Build 7102v09 (7102v09) (Date: Dec 12 18:02,
2019)</SoftwareVersion>
            <RipStationInfo>KITL2 - test -_DEMO_0421_</RipStationInfo>
            <RipDateTimeInfo>01/08/2020 00:50:49</RipDateTimeInfo>
            <PrintingTime>00:00:29</PrintingTime>
            <InkCoverage>C = 9236.3 nl, M = 9864.8 nl, Y = 0.014 ml, K = 0.00 pl, W = 1.38 ml</InkCoverage>
            <InkCost>$0.19</InkCost>
            <TotalCost>$0.19</TotalCost>
            <OutputFiles>
              <count>1</count>
              <OutputFiles1>Z:\8951_810922front.prn</OutputFiles1>
            </OutputFiles>
          </DetailStatus>
        </CopyDetail>
        <CopyDetail>
          <CopyNo>0</CopyNo>
          <PrintID>8951_810922front</PrintID>
          <OutputStatusCode>1</OutputStatusCode>
          <OutputStatusMessage>OK</OutputStatusMessage>
          <PrinterModel>Aeoon</PrinterModel>
          <PrinterName>Aeoon</PrinterName>
          <SoftwareVerson>Version 7.1.0.2 - Build 7102v09 (7102v09) (Date: Dec 12 18:02,
2019)</SoftwareVersion>
          <RipStationInfo>KITL2 - test -_DEMO_0421_</RipStationInfo>
          <RipDateTimeInfo>01/08/2020 00:50:49</RipDateTimeInfo>
          <PrintingTime>00:00:29</PrintingTime>
          <InkCoverage>C = 9236.3 nl, M = 9864.8 nl, Y = 0.014 ml, K = 0.00 pl, W = 1.38 ml</InkCoverage>
          <InkCost>$0.19</InkCost>
          <TotalCost>$0.19</TotalCost>
          <OutputFiles>
            <count>1</count>
            <OutputFiles1>Z:\8951_810922front.prn</OutputFiles1>
          </OutputFiles>
        </CopyDetail>
      </OUTPUT_STATUS>
      <MASTER_OUTPUT_STATUS>
        <OutputStatusCode>1</OutputStatusCode>
        <OutputStatusMessage>OK</OutputStatusMessage>
        <PrinterModel>Aeoon</PrinterModel>
        <PrinterName>Aeoon</PrinterName>
        <SoftwareVersion>Version 7.1.0.2 - Build 7102v09 (7102v09) (Date: Dec 12 18:02,
2019)</SoftwareVersion>
        <RipStationInfo>KITL2 - test -_DEMO_0421_</RipStationInfo>
        <RipDateTimeInfo>01/08/2020 00:50:49</RipDateTimeInfo>
        <PrintingTime>00:00:29</PrintingTime>
        <InkCoverage>C = 9236.3 nl, M = 9864.8 nl, Y = 0.014 ml, K = 0.00 pl, W = 1.38 ml</InkCoverage>
        <InkCost>$0.19</InkCost>
        <TotalCost>$0.19</TotalCost>
        <OutputFiles>
          <count>1</count>
          <OutputFiles1>Z:\8951_810922front.prn</OutputFiles1>
        </OutputFiles>
      </MASTER_OUTPUT_STATUS>
    </Step3>
    <Step4>
      <Name>Shipment</Name>
      <Host>KITL2</Host>
    </Step4>
    <Step5>
      <Name>Done</Name>
      <Host>KITL1</Ho.st>
    </Step5>
    <SourceStation>KITL1</SourceStation>
    <CurrentStep>5</CurrentStep>
    <NextStep>5</NextStep>
    <PreviousStep>4</PreviousStep>
    <LastStatusCode>1</LastStatusCode>
    <TrackingStatusMessage>OK</TrackingStatusMessage>
  </TrackingInfo>
  <ProcessInfo>
    <ProcessName>Simplified</ProcessName>
    <TotalSteps>5<TotalSteps>
    <Step1>
      <Name>Error<Name>
      <Host>KITL1</Host>
    </Step1>
    <Step2>
      <Name>MaterialAllocation</Name>
      <Host>KITL2</Host>
    </Step2>
    <Step3>
      <Name>Print</Name>
      <Host>KITL2</Host>
    </Step3>
    <Step4>
      <Name>Shipment</Name>
      <Host>KITL2</Host>
    </Step4>
    <Step5>
      <Name>Done</Name>
      <Host>KITL1</Host>
    </Step5>
  </ProcessInfo>
  <ReportingInfo>
    <ReportingStationVersion>1</ReportingStationVersion>
    <ReportingStation>KITL1</ReportingStation>
    <ReportingFolder>C:\KITL Automation\TP Hot</ReportingFolder>
  </ReportingInfo>
  <GlobalInfo>
    <OriginalPrintID>8951_810922</OriginalPrintID>
    <OriginalTotalCopies>1</OriginalTotalCopies>
    <TotalCopies>1</TotalCopies>
    <CopyNumbers>1</CopyNumbers>
    <OrderID>8951_8</OrderID>
    <ItemNo>10922</ItemNo>
    <BarcodeGenerationType>0</BarcodeGenerationType>
    <BarcodeGenerationSeparator>#</BarcodeGenerationSeparator>
    <ArticleInfo>
      <ArticleType>Tshirt</ArticleType>
      <PrintLocation>front</PrintLocation>
    </ArticleInfo>
    <OrderInfo>
      <OrderData>
        <OrderNo>8951</OrderNo>
        <OrderID>Order_8951</OrderID>
        <ItemNo>10922</ItemNo>
        <ArticleType>Tshirt</ArticleType>
        <ArticleLocation>front</ArticleLocation>
        <TrackingProcessSelection>Simplified</TrackingProcessSelection>
        <PrintCopies>1</PrintCopies>
        <PrintQueue>Queue 3</PrintQueue>
        <Path>https://windows.net/print-files/10922_2020-01-08-08_46_04_219807.png</Path>
        <PlatenName>Shirtboard 34x28</PlatenName>
        <InkType>Default Ink</InkType>
        <MediaType>Generic Media</MediaType>
        <PrintingBackground>Black</PrintingBackground>
        <BrandName>Generic Brand</BrandName>
        <PartName>SS Black Media 3-3</PartName>
        <ColorName>Black</ColorName>
        <SizeType>AsInDoc</SizeType>
        <Width>0</Width>
        <Height>0</Height>
        <Units>inch</Units>
        <Position>Center</Position>
        <X>0</X>
        <Y>0</Y>
        <Color>Black</Color>
        <Size>2XL</Size>
        <Brand>Gildan</Brand>
        <PSIN>gildan-18500-black-2xl</PSIN>
        <WeightUnit>oz</WeightUnit>
        <WeightValue>5</WeightValue>
        <NoOfPieces>1</NoOfPieces>
        <S_PersonName>Abc Xyz</S_PersonName>
        <S_AddressLine1>Abc BRIARTRACE CT</S_AddressLine1>
        <S_CityName>HOUSTON</S_CityName>
        <S_StateOrProvinceCode>TX</S_StateOrProvinceCode>
        <S_PostalCode>77044</S_PostalCode>
        <S_CountryCode>US</S_CountryCode>
        <QtyToShip>1</QtyToShip>
        <TotalPrice>15</TotalPrice>
        <R_PersonName>Pqr Efg</R_PersonName>
        <R_AddressLine1>400 Treat Ave</R_AddressLine1>
        <R_AddressLine2>Suite G</R_AddressLine2>
        <R_CityName>San Francisco</R_CityName>
        <R_StateOrProvinceCode>CA</R_StateOrProvinceCode>
        <R_PostalCode>94110</R_PostalCode>
        <R_CountryCode>US</R_CountryCode>
      </OrderData>
    </OrderInfo>
    <PrintID>8951_810922front</PrintID>
  </GlobalInfo>
  <JobSheet>
    <PrintLocation>front</PrintLocation>
    <Image>https://windows.net/print-files/10922_2020-01-08-08_46_04_219807.png</Image>
    <PlatenName>2XL</PlatenName>
    <Width>0</Width>
    <Height>0</Height>
    <Position>Center</Position>
    <InkType>gildan-18500-black-2xl</InkType>
    <MediaType>Generic Media</MediaType>
    <PrintingBkg>Black</PrintingBkg>
    <BrandName>Hoodie</BrandName>
    <PartNumber>8951</PartNumber>
    <ColorName>Black</ColorName>
  </JobSheet>
  <Step2>
    <Brand>Gildan</Brand>
    <PartNumber>gildan-18500-black-2xl</PartNumber>
    <Color>Black</Color>
    <Size>2XL</Size>
  </Step2>
  <Step3>
    <PrintQueueName>Queue 3</PrintQueueName>
    <DeleteSourceImageAfterPrint>Yes</DeleteSourceImageAfterPrint>
    <PrintLocation>front</PrintLocation>
    <PRINT_JOB_INFO>
      <Path Resource =″C:\KITL Automation\Server Images\8951_810922front_20200108004623317.png″
SourceStation =″KITL1″>https://net/print-files/10922_2020-01-08-08_46_04_219807.png</Path>
      <PlatenName>Shirtboard 34x28</PlatenName>
      <InkType>Default Ink</InkType>
      <MediaType>Generic Media</MediaType>
      <PrintingBackground>Black</PrintingBackground>
      <BrandName>Generic Brand</BrandName>
      <PartNumber>SS Black Media 3-3</PartNumber>
      <ColorName>Black</ColorName>
      <Size units=″inch″>
        <Type>BestFitAsInDoc</Type>
        <Width>0</Width>
        <Height>0</Height>
      </Size>
      <Position units=″inch″>
        <Type>Center</Type>
        <X>0</X>
        <Y>0</Y>
      </Position>
    </PRINT_JOB_INFO>
  </Step3>
  <ShipDirect>
    <LineItemID>10922</LineItemID>
    <GenericOrderID>Order_8951</GenericOrderID>
    <SourceofJob>FTP</SourceofJob>
  </ShipDirect>
  <Step4>
    <WeightUnit>oz</WeightUnit>
    <WeightValue>15</WeightValue>
    <R_PersonName>Abc Xyz</R_PersonName>
    <R_AddressLine1>Abc BRIARTRACE CT</R_AddressLine1>
    <R_CityName>HOUSTON</R_CityName>
    <R_StateOrProvinceCode>TX</R_StateOrProvinceCode>
    <R_PostalCode>77044</R_PostalCode>
    <R_CountryCode>US</R_CountryCode>
    <QtyToShip>1</QtyToShip>
    <TotalPrice>15</TotalPrice>
    <CustomDescription>Tshirt</CustomDescription>
    <JobFetchDate>1_8_2020</JobFetchDate>
    <JobFetchTime>0_46_23_539</JobFetchTime>
    <UnitPrice>−1.0</UnitPrice>
    <TotalTipReceived>0.0</TotalTipReceived>
    <LineItemID>10922</LineItemID>
    <ShopifyOrderID>Order_8951</ShopifyOrderID>
    <FulfillmentService>Printforia</FulfillmentService>
    <SourceofJob>FTP_V1</SourceofJob>
    <Return_PersonName>Pqr Efg</Return_PersonName>
    <Return_EmailID>abe @ printforia.com</ Return_EmailID>
    <Return_AddressLine1>400 Treat Ave</Return_AddressLine1>
    <Return_AddressLine2>Suite G</Return_AddressLine2>
    <Return_CityName>San Francisco</Return_CityName>
    <Return_StatetOrProvinceCode>CA</Return_StatetOrProvinceCode>
    <Return_PostalCode>94110</Return_PostalCode>
    <Return_CountryCode>US</Return_CountryCode>
  </Step4>
  <LICENSE_INFO>
    <Application>Kothari XML Generator</Application>
    <StationInfo>KITL1 - test - _DEMO_0422_</StationInfo>
    <SoftwareVersion>Version 7.1.0.2 - Build 7102v07 (7102v07) (Date : Jan 02 13:22,
2020)</SoftwareVersion>
    <LicenseDateTimeInfo>2020-01-08 00:46:23</LicenseDateTimeInfo>
    <LicenseVersion>1</LicenseVersion>
    <LicenseCode>fb83c655ee2843b08cc7ae4b4cf45024803a0e3a173e1afacd58b6170204</LicenseCode>
  </LICENSE_INFO>
</JobTicket>
```

As can be seen from the example, it is possible to define completely new processes, execute them with the help of end point configuration to obtain desired outcome using the components of the present invention in a workflow.

### Implementation:

The various component of this apparatus can be implemented as an executable code/interpreted scripts for devices/computers that they are supposed to be residing on. The devices can be machines with embedded micro controllers, ASIC, IOT enabled devices, Tablets, Smartphones, PDAs etc. The apparatus consists of the devices/computers that are linked to each other using a data network, which can be both wired or wireless; or a Cloud implementation with various other independent components of the apparatus connected to it. The network can be based on various protocols like TCP/IP, AppleTalk, Internet etc. The choice of devices/computers/cloud and the networking are dictated by the end use.

There can be several variations possible to this invention that are obvious to a person skilled in art. An example of such a variation can be using the apparatus for automating the management process, which can be defined in a similar way to manufacturing process with order data being replaced with objective and shipment being replaced with the outcome. Another variation could be embedding another manufacturing process as a micro manufacturing process carried out by a stage in the parent manufacturing process. One more variation could be a Service where the request for a Service is fulfilled by executing a Process comprising of several Stages. All such variations are covered by the claims and the scope of the present invention.

### REFERENCES

[1] Extensible Markup Language (XML) 1.0—https://www.w3.org/TR/REC-xml/
[2] XML Schema Part 1: Structures—https://www.w3.org/TR/xmlschema-1/
[3] XML Schema Part 2: Datatypes—https://www.w3.org/TR/xmlschema-2/
[5] Internetworking with TCP/IP Vol I, Principles, Protocols and Architecture—by Douglas E corner and David L. Stevens.
[6] Internetworking with TCP/IP Vol II, Design, Implementation and Internals—by Douglas E corner and David L. Stevens.
[7] Internetworking with TCP/IP Vol III, Client-server programming and applications—by Douglas E corner and David L. Stevens.
[8] Computer Networking, A top down approach—by James F Kurose and Keith W Ross.

1. An apparatus for developing a process flow to allow an user to execute a manufacturing process, the apparatus comprises:
a) at least a data connector for allowing data connections between the apparatus and various associated input resources sequentially disposed including mapping between the data fetched and a job ticket derivable from the order data;
the job ticket comprises various data sections applicable to the process for manufacturing;
at least a job ticket generator for allowing user interaction with the input resources to carry out a plurality of task; and
at least a Process Creator to define and create the process Stages for the Process execution based on transformed data from the input resources;
b) at least one postal agent for moving a job ticket to its next destination based on tracking of information available inside the job ticket and updates the current status of the job and transmits to a control panel in every steps;
c) at least one job ticket server making available the applicable job ticket for execution of task, to a particular stage in the process;
at least one processing client for initiating a call to an end point, along with the job related data; and
at least one end point configurable for multitasking, connectable to a machine or a service or combination of both, assigned for processing the incoming job, and
d) at least a control panel for displaying the status of the process flow development at any given point of time, wherein the components (a to d) of said apparatus operably being connected in a network.

2. The apparatus as claimed in claim 1, wherein the process creator is configured to implement the user defined process, the definition comprising of:
a. defining various processing stages, along with its locations in the network,
b. defining data schema, associated with various steps defined in step a,
c. sequence of execution of the steps defined in step a.

3. The apparatus as claimed in claim 1, wherein the job ticket structure organized as sections, wherein said job ticket is defined as summation of data requirement and tracking information for the various stage in the process defined in claims 2a, 2b and 2c and other data requirement defined by the user to be captured from the input data sources.

4. The apparatus as claimed in claim 3, wherein the data connectors configurable to fetch the input data from any input data source, create a configurable mapping definition for mapping the input data to the data processed in the various sections of the job ticket.

5. The apparatus as claimed in claim 1, wherein the job ticket generator is configured to:
a) automatically create the job ticket using the data connectors; and
b) posts the job ticket created in the step a, to the postal agent.

6. The apparatus as claimed in claim 1, wherein the postal agent is associated with every stage in the process and the job ticket generator, so that the Job Ticket is forwarded from first stage to the next stage based on the tracking information present in the job ticket.

7. The apparatus as claimed in claim 1, wherein the job ticket server is enabled to:
a. act as a repository of job tickets, received from the associated postal agent;
b. get connected to various processing clients;
c. provide the requested job ticket to the processing clients;
d. receive the job ticket back with the processing status from the processing client; and
e. forward the job ticket to the next stage through the associated postal agent.

8. The apparatus as claimed in claim 1, wherein the processing client is configured to:
a. get connected to the corresponding job ticket server;
b. connectable to the service(s)/machine(s) at the terminal end through an end point;
c. provide an interface to the end-user, for making a request for data associated with the particular stage from the job ticket server;
d. execute the command along with the data received in step c, to the endpoint for a stage related processing; and
e. transmit the data outputted at step d, along with the job ticket back to the job ticket server.

9. The apparatus as claimed in claim 8, wherein the end points can be configured using one or following combination:
a. using program scripts,
b. implementation of a data transfer Protocol using a communication/data port,
c. using WebSockets,
d. using internet protocol/web services, and
e. using IOT protocol.

10. The apparatus as claimed in claim 1, wherein the control panel is set up to:
a. receive a live feed from various stages in the process;
b. display the live status of every job;
c. provide control to cancel, pause or restart a job; and
d. provide the status of a job to an external node via a dedicated communication interface.

11. A method to operate the apparatus to execute a job, as claimed in claim 1, wherein the method comprising the steps of:
a. fetching the input data from input data sources and converting into Job tickets confirming to the user defined process;
b. pushing the job ticket into the workflow process, using the network of postal agents;
c. handing over the incoming job ticket, by each postal agent at real time, to the associated job ticket server, and updating the status at the control panel;
d. creating the repository of the incoming jobs, by the job ticket server, and providing it for execution to the processing client on demand;
e. executing the job through configurable end points, by the processing client and transmitting the execution result back to the job ticket server along with the job ticket;
f. forwarding the updated job ticket to the postal agent by the job ticket server, for sending it to the next stage in the process; and
g. repeating the steps of (b) to (f) until the process gets completed.

12. The process as claimed in claim 11, wherein the process is used for manufacturing an article of utility.
